(19) United States
(12) Patent Application Publication
(10) Pub. No.: US 2013/0220369 A1
(43) Pub. Date: Aug. 29, 2013

(54) VEHICLE WASHING SYSTEM AND METHOD FOR WASHING VEHICLES IN THE VEHICLE WASHING SYSTEM

(71) Applicant: Georg Wimmer, Affing (DE)

(72) Inventor: Georg Wimmer, Affing (DE)

(73) Assignee: WASHTEC HOLDING GMBH, Augsburg (DE)

(21) Appl. No.: 13/822,172

(22) PCT Filed: Aug. 10, 2011
(86) PCT No.: PCT/EP2011/063766

§ 371 Date: May 16, 2013

(30) Foreign Application Priority Data
Sep. 13, 2010 (DE) 10 2010 037 505.5

(51) Int. Cl. B60S 3/06

(52) U.S. Cl. CPC B60S 3/063
USPC 134/6; 15/53.1

(57) ABSTRACT

The invention relates to a vehicle washing system (1) having a conveying device for transporting vehicles (2, 3) to be washed in a conveying direction (4) along a plurality of treatment devices (11′-14′), wherein at least two of the treatment devices (11′-14′) for washing the front faces, rear faces and side faces of the vehicles (2, 3) are oriented vertically, and a method for washing vehicles (2, 3) which are conveyed one behind the other in the conveying direction (4) through the vehicle washing system (1). The invention solves the problem of reducing the mechanical loading on the individual parts of the vehicle washing system and of permitting more uniform and faster washing of the vehicles in the washing system, with a vehicle washing system in which the treatment devices (11′-14′) which are oriented vertically are arranged both in the conveying direction (4) and transversely with respect to the conveying direction (4) such that they can be moved independently of one another over the width of the vehicles (2, 3) to be washed, and a method in which each vertical treatment device (11′-14′) passes through, when viewed from above, a closed movement path (18; 26) in just one movement direction (25; 27).

The invention relates to a vehicle washing system according to the preamble of claim 1 and to a method for washing a plurality of vehicles conveyed one after the other in a conveying direction through the vehicle washing system according to the preamble of claim 5.

EP 748 729 A1 discloses a vehicle washing system that has a conveying device with at least one conveyor chain, by means of which the vehicles are moved through the system, wherein several treatment units for washing and optionally for drying the vehicle are provided along the conveyance path of the vehicle. At least one of the treatment units is mounted in a holder which can be moved forward in some sections, synchronously with the vehicle, and which can be moved backwards by means of a resetting device into their starting position.

To be able to wash the transported vehicle completely and continuously at a travel rate in such vehicle washing systems, the washing brushes, which are suspended vertically as a rule, can be carried along at least in some sections in the conveying direction of the vehicle, in particular in order to be able to wash the front faces and the rear faces of the vehicles, which extend vertically with respect to the conveying direction. For this purpose, two washing brushes are provided one after another in portal-like holders, wherein the portals can be moved over a certain distance, parallel to the conveying direction of the vehicle. The washing brush can in addition be moved vertically with respect to the conveying direction at the portal from one vehicle side to the other vehicle side and back again. There, the front washing brush, in the conveying direction, first washes the front as the vehicle is transported past it, and it is moved by means of its portal in the conveying direction of the vehicle and transversely with respect to said latter direction, until the washing brush has reached the vehicle side opposite its starting position. Subsequently, one vehicle side is cleaned by moving the washing portal past it and by moving the vehicle past it in the conveying direction. The cleaning of the following vehicles occurs by means of the subsequent, rear washing brush, in the conveying direction, which first washes the other vehicle side, and subsequently the rear by moving the second portal in the conveying direction and the washing brush from the first side to the second vehicle side.

The movement path of the washing brushes here describes in each case an L-shaped path, i.e., the washing brushes move back again into their starting position, on the same path on which they were moved to the end position of the first partial washing process. This means that the drives for transporting the washing brush, at least during the reversal of the movement path, in the washing end position, perform relatively strong movement changes in the opposite direction, as a result of which the mechanical loads on the bearings, drives and portals of the vehicle washing system are increased.

DE 1 954 259 relates to a method and to a device for washing or drying motor vehicles that are passing through, in which at least one rotating washing brush is used for the sequential washing or drying of the vehicle faces that are transverse to the movement direction and parallel to this movement direction. Here, a brush carrier is provided for the only one washing brush, which is mounted so it swings vertically. This washing brush at first washes the entire front of the vehicle, then a longitudinal side, and finally the entire rear. In order to wash the other longitudinal side, a second brush carrier having a further washing brush can be provided, which is moved in the opposite direction, that is, it passes at first over the entire front, and then over the other longitudinal side, and finally over the entire rear. After the termination of a washing process, these brushes must be returned to their starting position before the next vehicle can be washed. The disadvantage here is that one washing brush has to wash three sides of the vehicle, such that it can be moved back again into its base position. The washing of a vehicle thus takes a relatively long time, since, in order to wash the front of a subsequent vehicle, one must first wait until the rear of the previously moving vehicle has been washed, in order to prevent a collision of the washing brushes during the movement in the transverse direction between the vehicles. In addition, a non-uniform cleaning of the different vehicle sides is obtained there, since the front and the rear in each case are washed twice, while the longitudinal sides are each washed only once.

Therefore, the problem of the invention is to provide a vehicle washing system and a method for washing a vehicle in a washing system, which remedy the above-mentioned disadvantages, and which reduce the mechanical loading on the individual parts of the vehicle washing system. In a similar manner, this permits a more uniform and faster washing of the vehicle in the washing system.

The invention solves this problem by means of a vehicle washing system that has the characteristics of claim 1 and by a method for washing vehicles which are conveyed continuously one after the other in a conveying direction through the vehicle washing system that has the characteristics of claim 5. Advantageous embodiments and useful variants of the invention are indicated in the dependent claims.

A device mentioned at the start is characterized according to the invention in that the vertically-oriented treatment devices are arranged both along and also transversely to the conveying direction such that they can be moved independently of one another over the width of the vehicle to be washed. As a result, each one of the vertical treatment devices can advantageously pass—when viewed from above—through a closed movement path in just one movement direction.

In an advantageous variant, the vehicle washing system can comprise four vertically- oriented treatment devices, which can be moved in the conveying direction and also transversely with respect to said direction over the width of the vehicle to be washed. As a result, particularly if, in a variant according to the invention of the vehicle washing system, the treatment devices are washing brushes which can be driven in rotation and which have substantially vertically extending rotation axes, and half of the total number of washing brushes present turn exclusively in one rotation direction and the other half of the washing brushes turn exclusively in the opposite rotation direction, the front faces, rear faces and side faces of the vehicles are cleaned particularly thoroughly, since each one of these faces is cleaned by two washing brushes, in particular in two rotation directions.

In an advantageous embodiment of the invention, the movement path can be a double loop, wherein each treatment device passes clockwise through a first loop and counterclockwise through a second loop.

In a further advantageous embodiment, the movement path can be in the form of two triangles whose apexes are on top of each other, with bases which are parallel to each other and to the conveying direction, wherein each treatment device passes counterclockwise through the first triangle and clockwise through the second triangle. In an operationally advantageous variant, the triangles can be triangles which, in regard to their mutually contacting apexes, are isosceles triangles, in particular equilateral triangles.

It is preferable that each vertical treatment device passes only once in a complete pass through the closed movement path through each section of the movement path, such that abrupt direction changes of the treatment device, which apply particularly strong loading on its mechanical parts, do not occur.

In an advantageous variant of the invention, a first treatment device can move: a1) for treating the front of a first vehicle both along and also transversely to the conveying direction, then a2) for treating a first side face of the first vehicle on the side along said first side face against the conveying direction to its rear, then a3) for treating the front of a second vehicle both along and also transversely to the conveying direction, and then a4) for treating a second side face of the second vehicle, which is opposite the first side face of the first vehicle and of the second vehicle, on the side along said second side face against the conveying direction to its rear.

In a further advantageous additional variant of the invention, a further treatment device, particularly one located in the conveying direction behind the first treatment device, can move b1) for treating a second side face of the first vehicle, which is opposite the first side face of the first vehicle, on the side along said second side face against the conveying direction to its rear, then b2) for treating the rear of the first vehicle both along and also transversely to the conveying direction, then b3) for treating a first side face of the second vehicle, which is opposite the second side face of the second vehicle, on the side along said first side face against the conveying direction to its rear, and then b4) for treating the rear of the second vehicle both along and also transversely to the conveying direction.

In addition or alternatively, in a further advantageous variant of the invention, a further treatment device, particularly one located in the conveying direction behind the first treatment device, can move: c1) for treating the front of the first vehicle both along and also transversely to the conveying direction, then c2) for treating the first side face of the first vehicle, on the side along said first side face against the conveying direction to its rear, then c3) for treating the front of the second vehicle both along and also transversely to the conveying direction, and then c4) for treating the second side face of the second vehicle, on the side along said second side face against the conveying direction to its rear.

Additionally or alternatively, in a further advantageous variant of the invention, a further treatment device, particularly one located in the conveying direction behind the first treatment device, can move: d1) for treating a second side face of the first vehicle, which is opposite the first side face of the first vehicle, on the side along said second side face against the conveying direction to its rear, then d2) for treating the rear of the first vehicle both along and also transversely to the conveying direction, then d3) for treating a first side face of the second vehicle, which is opposite the second side face of the second vehicle, on the side along said first side face against the conveying direction to its rear, and then d4) for treating the rear of the second vehicle both along and also transversely to the conveying direction.

Advantageously, the treatment devices can comprise washing brushes that turn about substantially vertical rotation axes, wherein consecutive washing brushes, which clean the same faces of the vehicle, always turn in mutually opposite rotation directions.

Additional features and advantages of the invention can be obtained from the description of preferred embodiments in reference to the drawings. The drawings show:

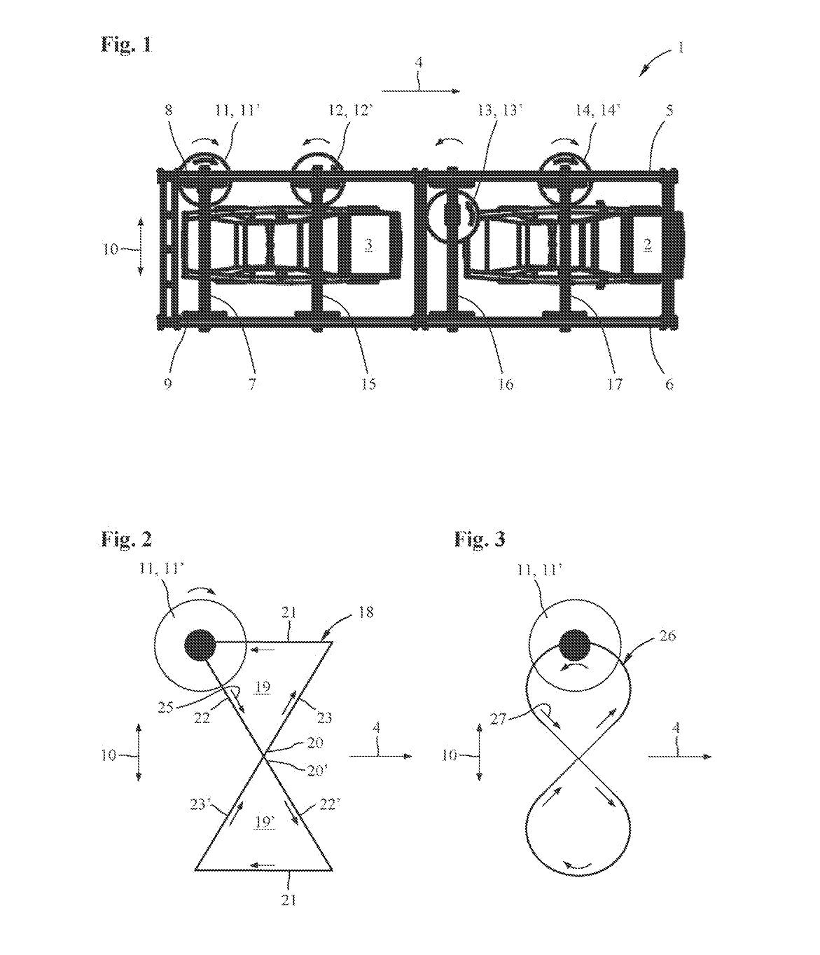

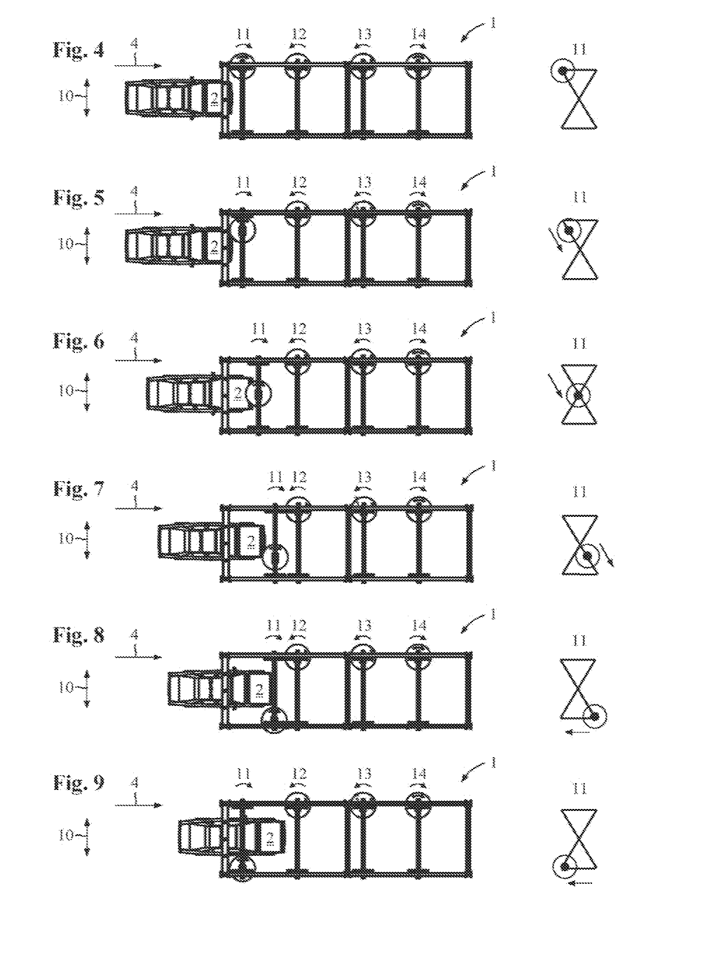

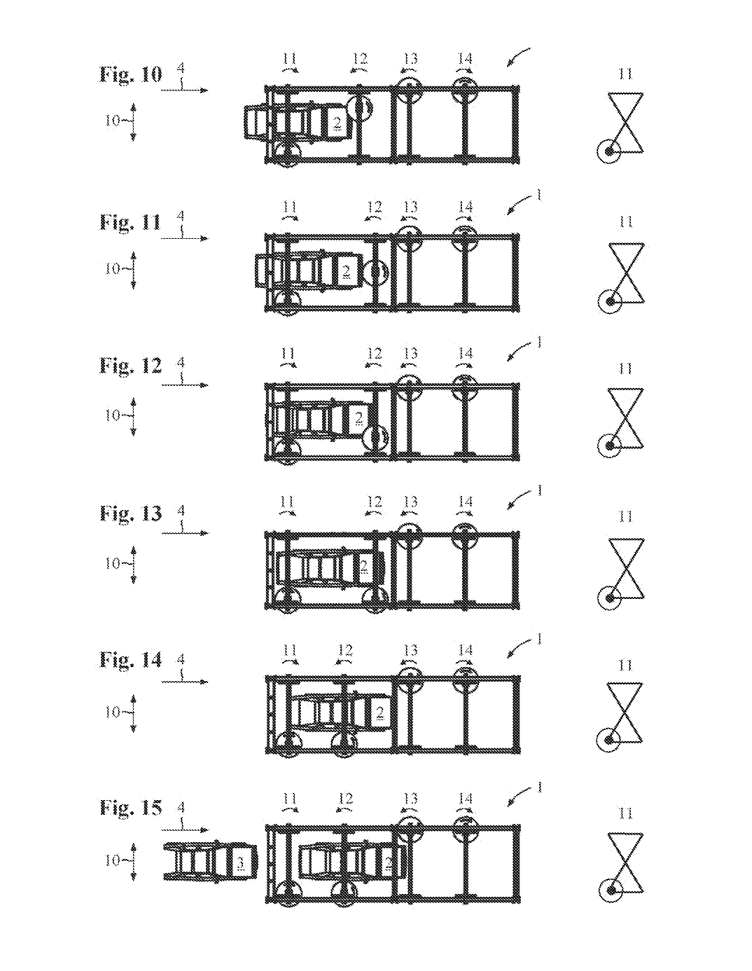

FIG. 1, a diagrammatic top view of a vehicle washing system according to the invention from above;

FIG. 2, a diagrammatic top view of a movement path of a treatment device of the vehicle washing system of FIG. 1 from above;

FIG. 3, a diagrammatic top view of an alternative movement path of a treatment device of the vehicle washing system of FIG. 1 from above; and

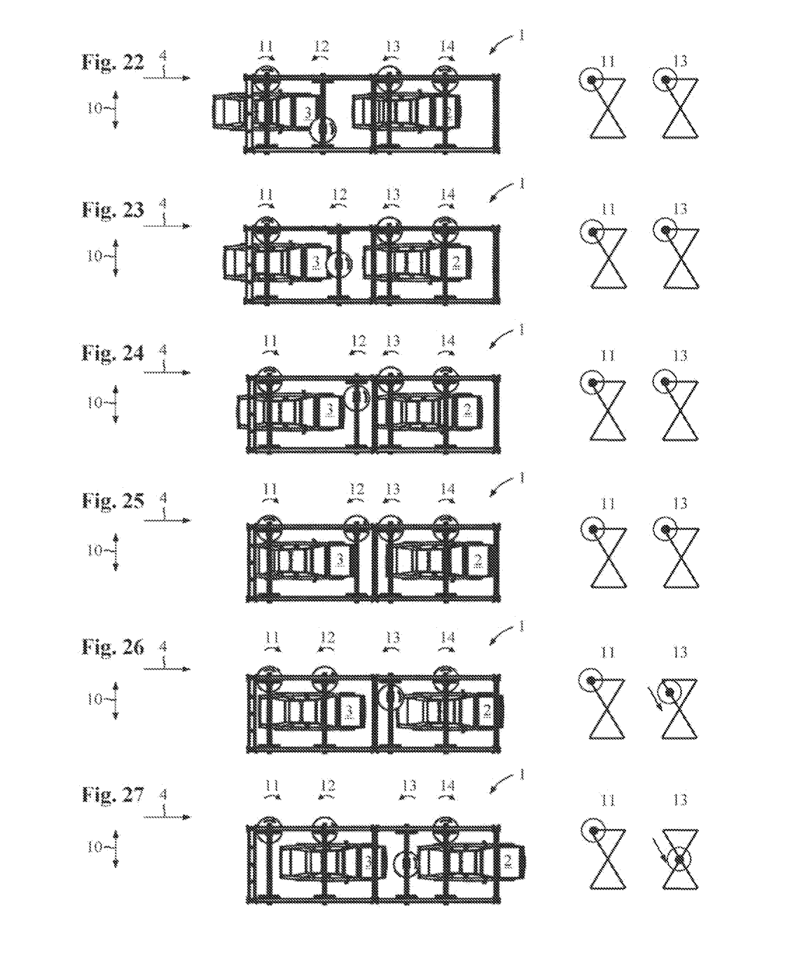

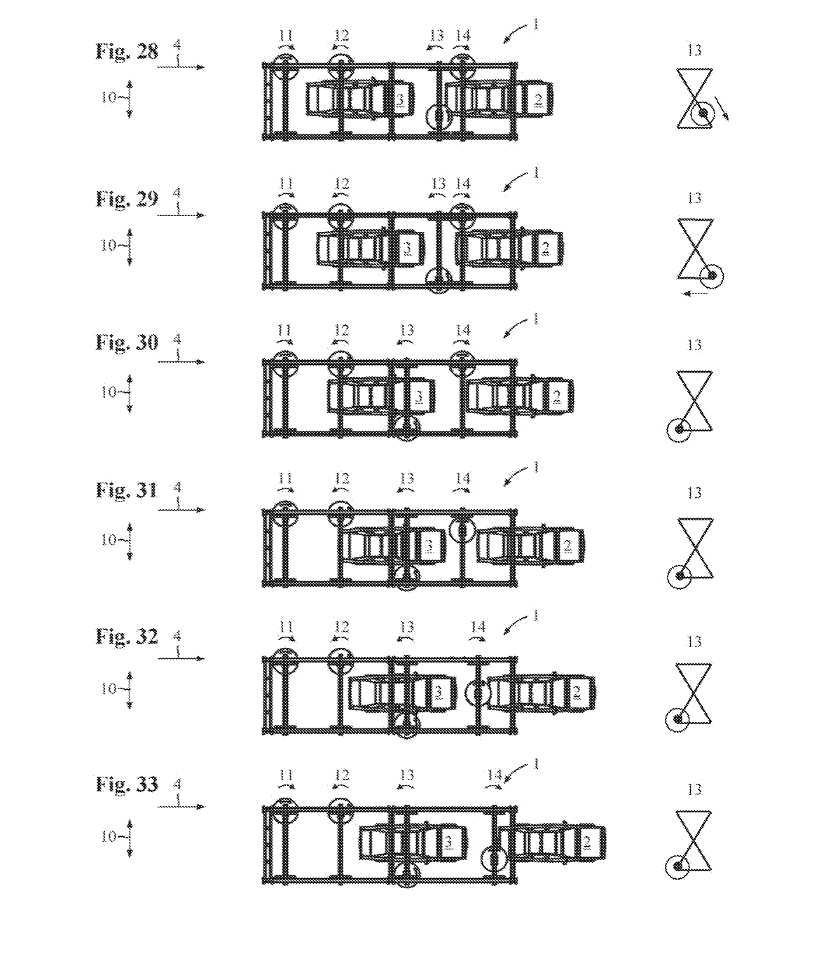

FIGS. 4-45, diagrammatic top views of the vehicle washing system of FIG. 1 from above showing different operating positions of the treatment devices.

FIG. 1 shows a vehicle washing system according to the invention designed as a pass-through car wash, referred to below simply as car wash 1. In the car wash 1, vehicles 2, 3 to be washed in a manner which in itself is known are conveyed by means of a conveying device, which is not shown, in a conveying direction 4 of the car wash. The car wash 1 comprises two stationary longitudinal supports 5, 6 arranged above the vehicles 2, 3. To said longitudinal supports, in the conveying direction 4, a first transverse support 7 is arranged such that it can be moved by means of bearing slides 8, 9 in and against the conveying direction 4 along the longitudinal supports 5, 6.

On the support frame/transverse support 7, a first treatment device is arranged, which is configured as first washing brush 11 and which can be moved transversely with respect to the conveying direction 4 in a transverse direction 10. Further further [sic] treatment devices, configured correspondingly as first, second and third washing brushes 12, 13 and 14, are arranged in a corresponding manner such that they can be moved in and against the conveying direction 4, on transverse supports 15, 16 and 17 arranged on the longitudinal supports 8 and 9. Since the washing brushes 11-14 are designed identically, primarily the first washing brush 11 is described in detail below, and corresponding explanations also apply to the other washing brushes 12, 13 and 14, unless otherwise indicated.

The washing brush 11 is arranged so it can be turned by means of a motor about a substantially vertical rotation axis on the transverse support 7. Since the transverse support 7 can be moved between the end positions shown in FIG. 1 and FIG. 8 in and against the conveying direction 4, it is possible to pass through a movement path 18 shown in FIG. 2, in interaction with the movability of the washing brush 11 in the transverse direction 10. The movement path 18 is composed of two isosceles triangles 19, 19′, which are on top of each other with their apexes 20, 20′, and whose bases 21 and 21′ extend parallel to each other and to the conveying direction 4.

In the embodiment of the invention shown in FIGS. 2 and 4-45, the washing brush 11 moves from the starting position shown in FIG. 2 or 4, first on the first arms 22 and 22′ of the triangles 19, 19′ to the corner of the lower triangle 19′ at the bottom on the right in FIG. 2, and then against the conveying direction 4 to the lower left corner of the lower triangle 19′, subsequently along two arms 23′ and 23 to the upper right corner of the upper triangle 19 in

FIG. 2, and subsequently from this corner back to the upper left corner in FIG. 2, that is, to the starting and thus also the end position. This results in the closed movement path 18, which is passed through in just one movement direction 25 indicated by arrows in FIG. 2. In particular, the washing brush 11 passes just once through each section of the movement path 18, in one complete pass through the closed movement path 18.

An alternative movement path 26, shown in FIG. 3, is in the form of a double loop, that is, in the form of an “8.” This path as well is passed through in just one movement direction 27, as indicated by the arrows in FIG. 3. The alternative movement path 26 is more complicated in terms of control technology, since, in the case of a given continuous conveyance speed of the vehicles 2, 3 in the conveying direction, the transverse support 7 has to be moved at different speeds in and against the conveying direction, and the washing brush 11 in the transverse direction 10 during the pass through the alternative movement path 26. However, it can be advantageous here to provide a very uniform pass through the movement path 26 with the washing brush 11, such that the mechanical loading on the concerned parts of the car wash 1, in particular on the longitudinal supports 5, 6, of the transverse support 7, on the bearing slides 8, 9, and on the holder of the washing brush 11 is decreased further in comparison to the movement path 18 shown in FIG. 2.

The movement path shown in FIG. 2 has the advantage that the advance of the washing brush 11 in the movement direction 25 can occur linearly, i.e., the washing brush 11 and the transverse support 7 can in each case be moved at a constant speed in the transverse direction 10, or in and against the conveying direction 4. In addition, these speeds can be adapted in a simple manner to the conveyance speed of the vehicles 2, 3, and synchronized with the movement of the vehicles 2, 3.

In contrast to the movement path described in the above-mentioned DE 295 09 750 U1, in which the treatment units move back and forth in an L-shaped pattern between two end positions, that is to say they have the same forward and return path, in the present invention, the movement direction 25 or 27 extends in only one direction in the movement path 18 or 26. On the other hand, in the known vehicle washing system, the vehicle direction is reversed in the L-shaped movement path.

Below, a complete washing process of the two vehicles 2 and 3 is explained with reference to FIGS. 4-45.

Here, the washing process by means of the first washing brush 11 and the associated movement path 18 of the washing brush 11 are represented in FIGS. 4-27.

In FIGS. 10-32, the washing process by means of the second washing brush 12 is represented, but without the associated movement path, since the movement path of the two washing brushes 12 corresponds to the movement path 18 of the first washing brush 1 with temporal and spatial offset.

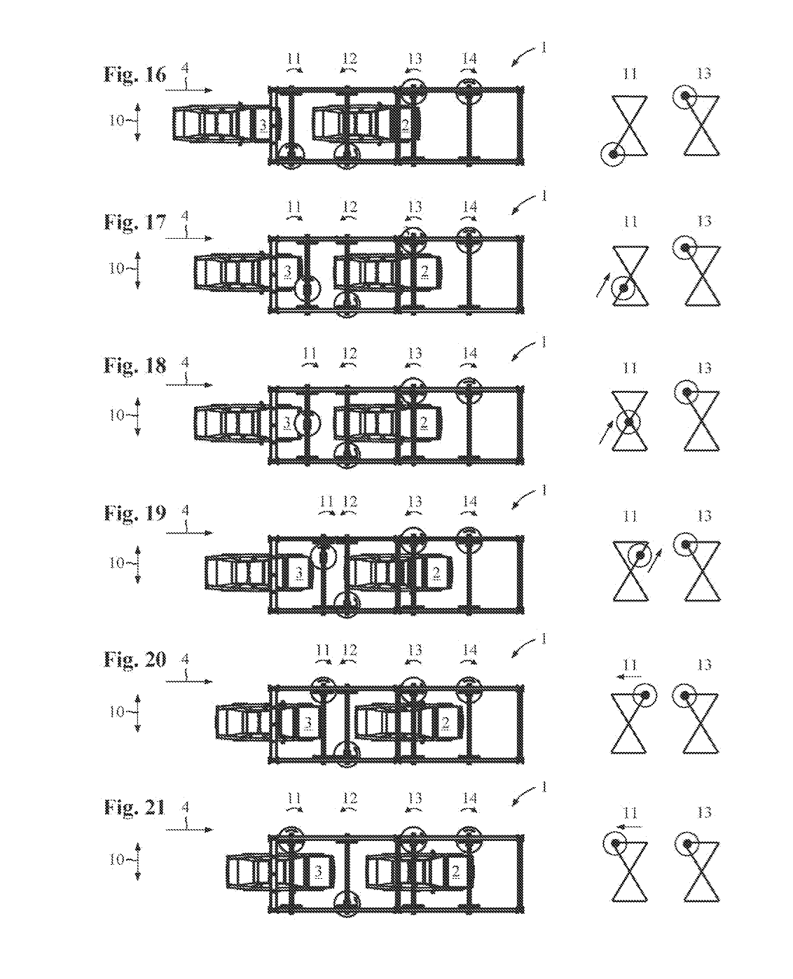

In FIGS. 16-41, the washing process by means of the third washing brush 13 is represented in each case with the associated movement path 18.

In FIGS. 21-44, the washing process by means of the fourth washing brush 14 is represented, but without the associated movement path, since the movement path of the fourth washing brush 14 corresponds to the movement path 18 of the third washing brush 13 with temporal and spatial offset.

In FIG. 4, the first vehicle 2 to be washed moves [sic] is conveyed by the conveying device in the conveying direction 4 into the car wash 1. From the starting position of the washing brush 11 shown in FIG. 4, said washing brush, for washing the front of the first vehicle, first moves at a slant forward in the conveying direction 4 in FIGS. 5-8, as can be seen from the movement of the washing brush 11 sketched on the right in the drawings. After the washing of the front of the first vehicle 2, while the right side of the first vehicle 2 undergoes cleaning in the conveying direction 4, the first washing brush 11 moves from the position shown in FIG. 8 into the position shown in FIG. 9, in which it remains until the right side of the first vehicle 2 is completely washed as a result of the transport past the first washing brush 11 in the conveying direction, and until the washing process of the second vehicle according to FIG. 16 starts.

The first washing brush 11 here always turns clockwise, as indicated by an arrow in the drawings.

In contrast, in the conveying direction 4, the second second [sic] washing brush 12 arranged behind the first washing brush 11 always turns counterclockwise. As can be seen particularly in FIGS. 10-21, the movement path of the second washing brush 12 and its pass corresponds to that of the first washing brush 11, since the second washing brush 12 cleans the same faces of the vehicles 2 and 3 as the first washing brush, however with the opposite rotation direction of the second washing brush 12.

As a result of the opposite rotation direction, it is possible in particular to wash the protrusions and the recesses of the vehicle faces to be cleaned from opposite directions, as a result of which the washing effect can be improved. For example, the first washing brush 11 is capable of washing an exterior mirror of the second vehicle 3, which is on the left, in the conveying direction 4, in FIG. 21, only from the front side, due to the clockwise rotation direction, while the rear side of the outside mirror, which is as a rule bent toward the rear, cannot be completely covered and cleaned by washing brushes rotating clockwise. For this purpose, the second washing brush 12 rotating counterclockwise in FIG. 26 is used. Similar statements apply conversely to the exterior mirror of the first vehicle 2, which is on the right in the conveying direction 4, and which can also be cleaned sufficiently on its rear side, in FIG. 9, by the first washing brush 11 which turns clockwise.

After the cleaning of the first vehicle 2 by means of the first washing brush 11, the latter, starting from FIG. 16, again moves, in the conveying direction 4, from the right side of the car wash 1, while the front of the second vehicle 3 undergoes cleaning, to the left vehicle side, in the conveying direction 4, that is to say toward the longitudinal support 5, as can be seen in FIGS. 16-20. Subsequently, in FIGS. 21-27, the left vehicle side of the second vehicle 3 is washed by the first washing brush 11, such that, in FIG. 27, the first washing brush 11 is again located in its rest position of FIGS. 1, 2 and 4.

Correspondingly, with temporal and spatial offset, the front of the second vehicle 3 in FIGS. 22-25 is washed again with the second washing brush 12, and the left vehicle side in FIGS. 26-32 is washed again with opposite rotation direction. The second washing brush 12 in FIG. 32 is then again located in its rest position shown in FIG. 9.

The washing brushes 13 and 14 are used to clean the rear as well as the vehicle sides of the vehicles 2 and 3 which have not yet been cleaned by the first and second washing brushes 11 and 12. In a manner corresponding to the washing brush pairs 11, 12, the washing brushes 13 and 14 move in the same manner on corresponding movement paths 18 and in each case they turn in the opposite rotation direction. In this manner, the third washing brush 13 turns counterclockwise, while the fourth washing brush 14 turns clockwise. In principle, the rotation directions of the third and fourth washing brushes 13 and 14—like those of the first and second washing brushes 11 and 12—can be mutually exchanged. The determining factor is that the washing brushes, which in each case clean the same vehicle faces, turn in opposite directions.

At the position shown in FIG. 16, the washing process of the left vehicle side of the first vehicle 2 begins by means of the third washing brush 13, which must not be moved, up to the position shown in FIG. 25, since the first vehicle 2 is moved past the washing brush 13 by the conveying device, which is not shown.

The rear of the first vehicle 2 is then passed, by moving the third washing brush 13 from the position shown in FIG. 25, through the positions shown in FIGS. 26-28, on the movement path 18 shown to the far right in these drawings.

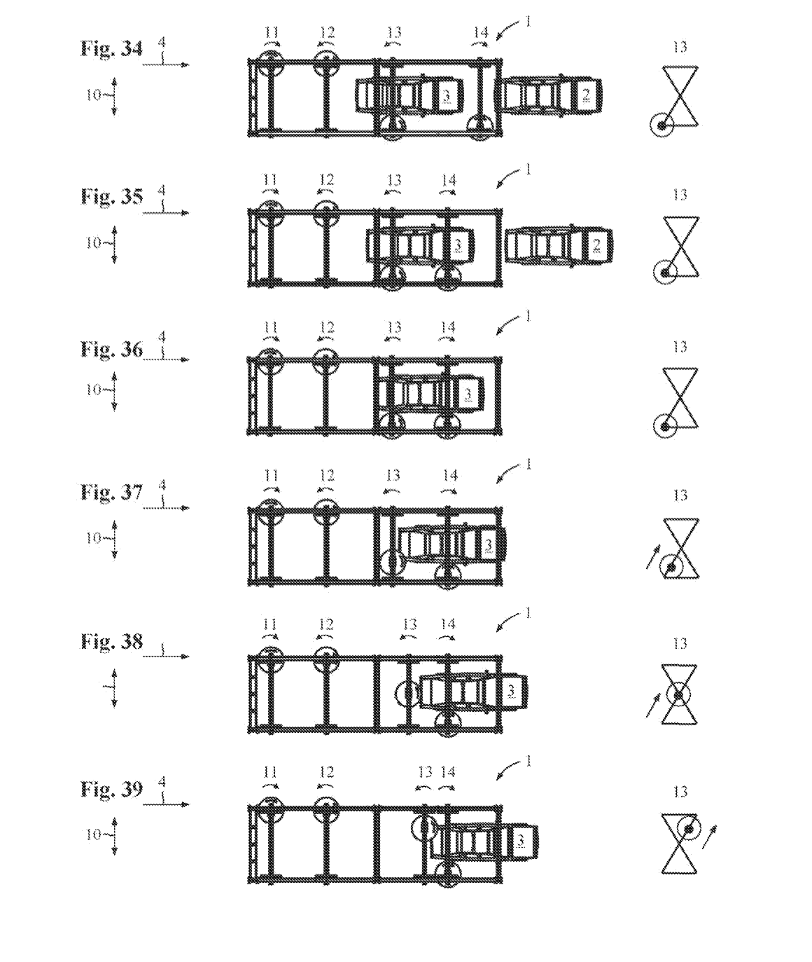

In the same manner, the fourth washing brush 14 cleans, with the rotation direction opposite the third washing brush 13, the right vehicle side of the first vehicle 3 starting with FIG. 21 and ending with FIG. 30. Similarly, the rear of the first vehicle 2, starting with FIG. 30 and ending with FIG. 34, is cleaned by means of the fourth washing brush 14, such that the first vehicle 2 in FIG. 35 can be moved out of the car wash 1, and the washing process of the first vehicle 2 is terminated.

The cleaning of the right side face of the first vehicle 3, which has not yet been washed by the first two washing brushes 11 and 12, by means of the third washing brush 13 starts with FIG. 29, wherein the third washing brush 13 moves from FIG. 29 to FIG. 30 again into the lower left corner position of its movement path 18. Subsequently, the washing brush 13 remains in this position until the end of the cleaning of the right vehicle side of the second vehicle 3 in FIG. 36.

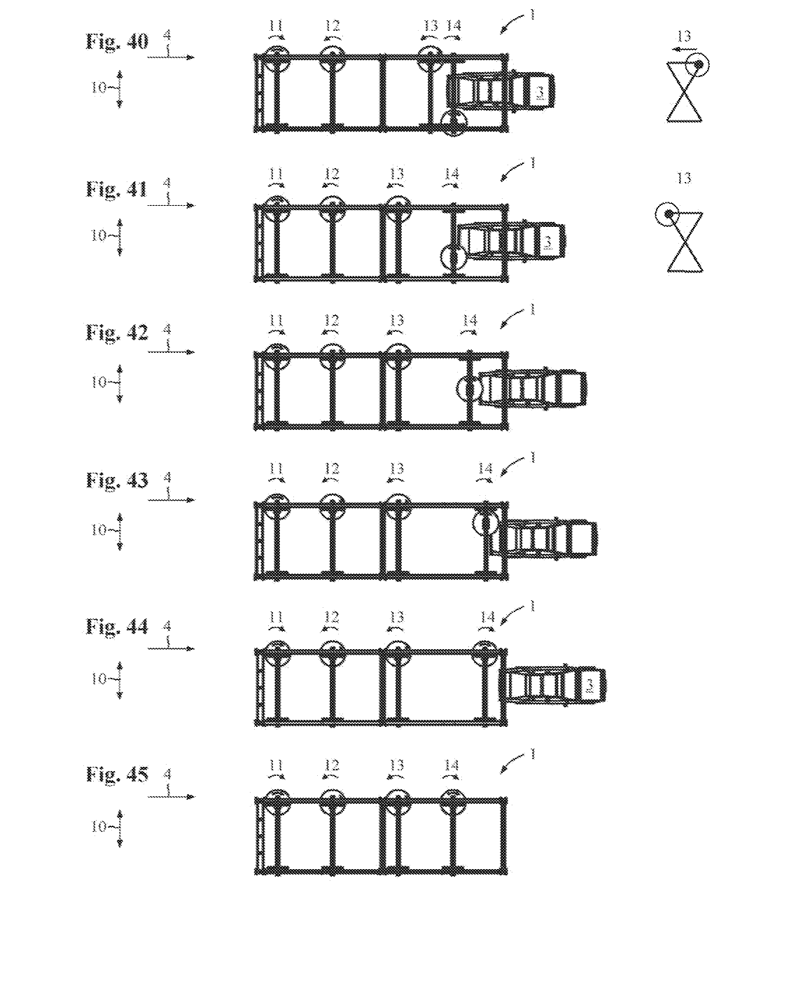

Starting with FIG. 37 and ending in FIG. 40, the third washing brush 13 subsequently moves in the direction shown in FIGS. 37-39 along the rear of the second vehicle 3, until the cleaning thereof with the third washing brush 13 in FIG. 14 is completed.

Similarly, the fourth washing brush 14, starting with FIG. 34 and ending between FIGS. 40 and 41, cleans the right vehicle side of the second vehicle 3 with reversed rotation direction of the fourth washing brush 14. In the process, the fourth washing brush 14 moves between FIGS. 34 and 35 on the arm 21 of the lower triangle 19′ in FIG. 2 against the conveying direction 4 and cleans at the same time. Starting with FIG. 40, the rear of the second vehicle 3 is then cleaned by moving the fourth washing brush 14 on the portion of the movement path 18 that is formed by the arms 23′ and 23, until the position shown in FIG. 44 is reached. Subsequently, the fourth washing brush 14 then moves again on the base 21 of the top triangle 19 of the movement path 18, in FIG. 2, back into the upper rest position to the far left in FIG. 2.

If, in contrast to the washing process shown in FIGS. 4-45, only one vehicle is to be cleaned because the car wash 1 is used only infrequently, then the washing brushes 11-14 remain in each case after the end of their washing process of the first vehicle 2 of the above embodiment example. When the next vehicle is to be washed, the movement path 18 of the respective washing brush 11-14, which has already started, is continued in each case until the brushes again reach the original starting or rest position.

1-13. (canceled)

14. Vehicle washing system having a conveying device for transporting vehicles to be washed in a conveying direction along a plurality of treatment devices, wherein at least two of the treatment devices for washing the front faces, rear faces and side faces of the vehicles are oriented vertically, wherein the vertically-oriented treatment devices are arranged both along and also transversely to the conveying direction such that they can be moved independently of one another over the width of the vehicle to be washed.

15. Vehicle washing system according to claim 14, wherein the system comprises four vertically-oriented treatment devices, which can be moved in the conveying direction and also transversely with respect to said conveying direction over the width of the vehicles to be washed.

16. Vehicle washing system according to claim 14, wherein the treatment devices are washing brushes which can be driven in rotation, with rotation axes that extend substantially vertically, and half of the total number of washing brushes present always turn in one rotation direction and the other half of the washing brushes always turn in the opposite direction.

17. Vehicle washing system according to claim 15, wherein, when viewed in the conveying direction, the rotation direction of the first washing brush and of the last washing brush is always opposite the rotation direction of the second washing brush and third washing brush located in between.

18. Method for washing vehicles conveyed one after the other in the conveying direction through a vehicle washing system according to claim 1, wherein each vertical treatment device, when viewed from above, passes through a closed movement path in one movement direction.

19. Method according to claim 18, wherein the movement path is a double loop, wherein each treatment device passes clockwise through a first loop and counterclockwise through a second loop.

20. Method according to claim 18, wherein the movement path is in the form of two triangles whose apexes are on top of each other, with bases which are parallel to each other and to the conveying direction, wherein each treatment device passes counterclockwise through the first triangle and clockwise through the second triangle.

21. Method according to claim 20, wherein the triangles, with regard to their mutually contacting apexes, are isosceles triangles, in particular equilateral triangles.

22. Method according to claim 18, wherein each vertical treatment device passes only once in a complete pass through the closed movement path through each section of the movement path.

23. Method according to claim 18, wherein a first treatment device moves
a1) for treating the front of a first vehicle both along and also transversely to the conveying direction, then
a2) for treating a first side face of the first vehicle on the side along said first side face against the conveying direction to its rear, then
a3) for treating the front of a second vehicle both along and also transversely to the conveying direction, and then
a4) for treating a second side face of the second vehicle, which is opposite the first side face of the first vehicle and of the second vehicle, on the side along said second side face against the conveying direction to its rear.

24. Method according to claim 23, wherein a further treatment device, located in particular in the conveying direction behind the first treatment device, moves
b1) for treating a second side face of the first vehicle, which is opposite the first side face of the first vehicle, on the side along said second side face against the conveying direction to its rear, then
b2) for treating the rear of the first vehicle both along and also transversely to the conveying direction, then
b3) for treating a first side face of the second vehicle, which is opposite the second side face of the second vehicle, on the side along said first side face against the conveying direction to its rear, and then
b4) for treating the rear of the second vehicle both along and also transversely to the conveying direction.

25. Method according to claim 23, wherein a further treatment device, which is located in particular in the conveying direction behind the first treatment device, moves
c1) for treating the front of the first vehicle both along and also transversely to the conveying direction, then
c2) for treating the first side face of the first vehicle, on the side along said first side face against the conveying direction to its rear, then
c3) for treating the front of the second vehicle both along and also transversely to the conveying direction, and then
c4) for treating the second side face of the second vehicle, on the side along said second side face against the conveying direction to its rear.

26. Method according to claim 23, wherein a further treatment device, which is located in particular in the conveying direction behind the first treatment device, moves
d1) for treating a second side face of the first vehicle, which is opposite the first side face of the first vehicle, on the side along said second side face against the conveying direction to its rear, then
d2) for treating the rear of the first vehicle both along and also transversely to the conveying direction, then
d3) for treating a first side face of the second vehicle, which is opposite the second side face of the second vehicle, on the side along said first side face against the conveying direction to its rear, and then
d4) for treating the rear of the second vehicle both along and also transversely to the conveying direction.
